(19) United States
(12) Patent Application Publication
(10) Pub. No.: US 2025/0284362 A1
(43) Pub. Date: Sep. 11, 2025

(54) TOUCH PANEL, TOUCH DISPLAY PANEL, AND TOUCH DISPLAY DEVICE

(71) Applicant: Yungu (Gu’an) Technology Co., Ltd., Langfang (CN)

(72) Inventors: Xinglong HE, Langfang (CN); Kun HE, Langfang (CN)

(73) Assignee: Yungu (Gu’an) Technology Co., Ltd., Langfang (CN)

(21) Appl. No.: 19/218,562

(22) Filed: May 26, 2025

(30) Foreign Application Priority Data
May 29, 2024 (CN) 202410684536.3

(51) Int. Cl. G06F 3/041; G06F 3/044

(52) U.S. Cl. CPC G06F 3/04164; G06F 3/0446

(57) ABSTRACT

The present application discloses a touch panel, a touch display panel and a touch display device. The touch panel includes: a mesh electrode layer, including a first touch electrode, a second touch electrode and a first dummy electrode which are insulated from one another, and a plurality of first breaks, any two of the first touch electrode, the second touch electrode and the first dummy electrode having a part of the first breaks provided therebetween. An arrangement of adjacent first breaks of the plurality of first breaks is defined to form a dummy pattern, the dummy pattern including a plurality of polyline-shaped dummy repeating units. The present application can increase the dispersion of the first breaks to break the continuity of the breaks in a demarcation area, break shadows are then effectively reduced, and the display effect of the touch display panel is thus improved.

### CROSS-REFERENCE TO RELATED APPLICATIONS

The present application claims priority to Chinese Patent Application No. 202410684536.3, filed on May 29, 2024 and entitled “TOUCH PANEL, TOUCH DISPLAY PANEL, AND TOUCH DISPLAY DEVICE”, the disclosure of which is incorporated herein by reference in its entirety.

### FIELD

The present application relates to the field of display, and in particular to a touch panel, a touch display panel and a touch display device.

### BACKGROUND

With the development of display technology, more and more display panels are integrated with a touch function.

In the related art, in order to achieve the touch function, it is typically necessary to incorporate a metal mesh in a display panel and to cut the metal mesh in order to obtain a touch electrode.

However, a touch display panel with good performance cannot be fabricated in the related art.

### SUMMARY

In order to solve the above or other problems, the present application provides the following embodiments.

One embodiment of the present application is to provide a touch panel, including: a mesh electrode layer, including a first touch electrode, a second touch electrode and a first dummy electrode which are insulated from one another, and a plurality of first breaks, any two of the first touch electrode, the second touch electrode and the first dummy electrode having a part of the first breaks provided therebetween. An arrangement of adjacent first breaks of the plurality of first breaks is defined to form a dummy pattern, the dummy pattern including a plurality of polyline-shaped dummy repeating units.

The dummy repeating unit includes a first dummy polyline unit and a second dummy polyline unit connected end to end, and the dummy repeating unit is a W-like pattern. The number of first breaks distributed in the dummy repeating unit is 4 to 20.

The number of first breaks in the first dummy polyline unit is the same as the number of first breaks in the second dummy polyline unit. The number of first breaks in the first dummy polyline unit is 2 to 10. The number of first breaks in the first dummy polyline unit is 6 to 10. A distribution density of the first breaks in the first dummy polyline unit is the same as a distribution density of all the first breaks in the second dummy polyline unit.

The number of first breaks in the first dummy polyline unit is different from the number of first breaks in the second dummy polyline unit. The number of first breaks in the first dummy polyline unit is 2 to 4, and the number of first breaks in the second dummy polyline unit is 4 to 10.

The mesh electrode layer includes a plurality of conductive mesh lines; and the plurality of adjacent first breaks include a first break disposed at a vertex of a corresponding cell within the conductive mesh lines, and another first break disposed at a midpoint of a side of a corresponding cell within the conductive mesh lines.

In one embodiment, the dummy repeating unit includes dummy line segments, the plurality of first breaks in the dummy line segments being arranged along a diagonal line of a pattern formed by at least two adjacent cells.

In one embodiment, each dummy line segment includes three first breaks, the three first breaks being respectively located at two opposite vertices of at least two adjacent cells spanned by the dummy line segment, and at a midpoint of a shared side of the two adjacent cells.

Parts of the conductive mesh lines of the first sub-electrodes, the second sub-electrodes and the first dummy electrodes have a plurality of second breaks provided on.

A distribution density of the second breaks close to the first breaks is greater than a distribution density of the second breaks remote from the first breaks. The number of second breaks in a plurality of adjacent cells close to the first breaks is greater than the number of second breaks in a plurality of adjacent cells remote from the first breaks. The number of second breaks distributed in a square pattern formed by every four adjacent cells close to the first breaks is 5 to 8; and the number of second breaks distributed in a square pattern formed by every four adjacent cells remote from the first breaks is 0 to 4.

A plurality of second dummy electrodes are provided in the first sub-electrode, and the second dummy electrodes are insulated from the first sub-electrode; and/or a plurality of second dummy electrodes are provided in the second sub-electrode, and the second dummy electrodes are insulated from the second sub-electrode.

In order to solve the above problem, another embodiment of the present application is to provide a touch display panel, including a touch panel described above, where the touch display panel further includes a display panel stacked with the touch panel.

In order to solve the above problem, yet another embodiment of the present application is to provide a touch display device, including a touch display panel described above.

The present application has the following beneficial effects. Different from the related art, the present application provides the touch panel, the touch display panel and the touch display device, in which the first breaks are provided between the touch electrode and the first dummy electrode, the arrangement of adjacent first breaks of the plurality of first breaks is defined to form the dummy pattern, and the dummy pattern includes the plurality of polyline-shaped dummy repeating units, so that the dispersion of the first breaks can be increased to break the continuity of the breaks in a demarcation area, break shadows are then effectively reduced, and the display effect of the touch display panel is thus improved.

### BRIEF DESCRIPTION OF THE DRAWINGS

In order to more clearly illustrate the embodiments of the present application, the accompanying drawings required for the descriptions of examples will be briefly described below. The drawings in the following description are only some embodiments of the present application.

FIG. 1 is a structural schematic view of an implementation of a touch display panel of the present application;

FIG. 2 is a schematic view of the arrangement of first electrodes and second electrodes in the touch panel of FIG. 1;

FIG. 3 is a structural schematic enlarged view of an implementation of area A in FIG. 2;

FIG. 4 is a structural schematic enlarged view of a first implementation of area B in FIG. 3;

FIG. 5 is a structural schematic enlarged view of a second implementation of area B in FIG. 3;

FIG. 6 is a structural schematic enlarged view of a third implementation of area B in FIG. 3;

FIG. 7 is a structural schematic enlarged view of a fourth implementation of area B in FIG. 3;

FIG. 8 is a structural schematic enlarged view of a fifth implementation of area B in FIG. 3; and

FIG. 9 is a structural schematic enlarged view of an implementation of C area in FIG. 3.

### DETAILED DESCRIPTION OF THE EMBODIMENTS

The embodiments of the present application will be clearly and completely described below in conjunction with the accompanying drawings in the embodiments of the present application. Apparently, the embodiments described are merely some rather than all of the embodiments of the present application.

The terms used in the embodiments of the present application are merely for the purpose of describing specific embodiments, and are not intended to limit the present application. The terms “a/an”, “said” and “the” of singular forms used in the embodiments and the appended claims of the present application are also intended to include plural forms, unless otherwise specified in the context clearly, and the term “a plurality” generally includes at least two, but does not exclude at least one.

It should be understood that the term “and/or” herein is merely the description of an association between associated objects, and indicates that three relationships may exist. For example, A and/or B may indicate that only A exists, both A and B exist, and only B exists. In addition, the character “/” herein generally indicates that an “or” relationship between associated objects.

It should be understood that the terms “include”, “comprise”, or any other variants thereof are intended to cover a non-exclusive inclusion, so that a process, a method, an article, or a device that includes a list of elements not only includes those elements but also includes other elements that are not listed, or further includes elements inherent to such a process, method, article, or device. If no more limitations are made, an element limited by “including . . . ” does not exclude other identical elements existing in the process, the method, the article, or the device which includes the element.

In the related art, a touch panel generally includes a driving electrode (TX) and a sensing electrode (RX). The driving electrode is connected to an integrated circuit (IC) by means of a driving signal line, the sensing electrode is connected to the IC by means of a sensing signal line, and the IC identifies a touch operation by sending a driving signal to the driving electrode and by the sensing electrode receiving the sent driving signal. The driving electrode and the sensing electrode on the touch panel are metal meshes formed by conductive touch mesh lines, and it is necessary to separate the metal mesh forming the driving electrode from the metal mesh forming the sensing electrode by means of breaks to prevent short circuiting between the driving electrode and the sensing electrode. A conventional break arrangement extends in a vertical or horizontal direction according to the shape of a touch pattern. During strong light irradiation, side surfaces of the conductive mesh lines at the breaks will reflect light, while the breaks themselves do not reflect light, resulting in break shadows that seriously affecting visibility, and thus affecting the display effect.

In view of the above situation, the present application provides a touch panel, a touch display panel and a touch display device, which can solve the problem that a touch display panel with good performance cannot be fabricated in the above related art.

The touch panel according to the present application includes: a mesh electrode layer, including a first touch electrode, a second touch electrode and a first dummy electrode which are insulated from one another, and a plurality of first breaks, any two of the first touch electrode, the second touch electrode and the first dummy electrode having a part of the first breaks provided therebetween. An arrangement of adjacent first breaks of the plurality of first breaks is defined to form a dummy pattern, the dummy pattern including a plurality of polyline-shaped dummy repeating units. The first breaks are provided between the touch electrode and the first dummy electrode, the arrangement of adjacent first breaks of the plurality of first breaks is defined to form the dummy pattern, and the dummy pattern includes the plurality of polyline-shaped dummy repeating units, so that the dispersion of the first breaks can be increased to break the continuity of the breaks in a demarcation area, break shadows are then effectively reduced, and the display effect of the touch display panel is thus improved.

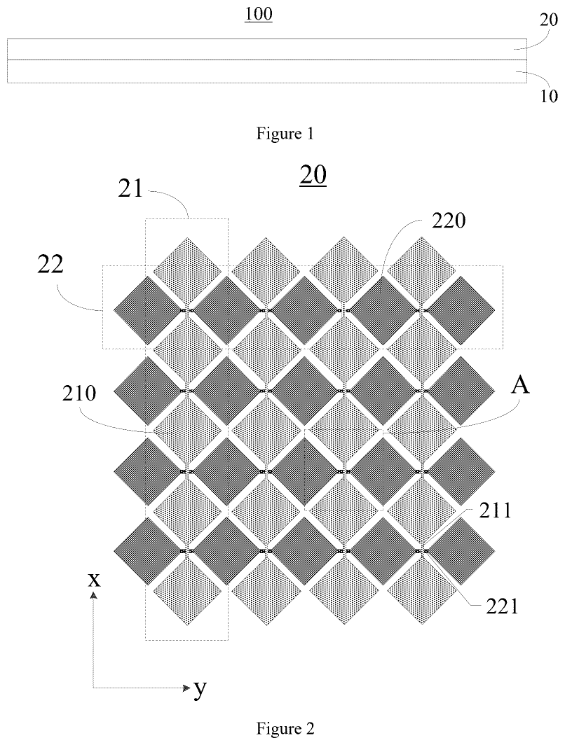

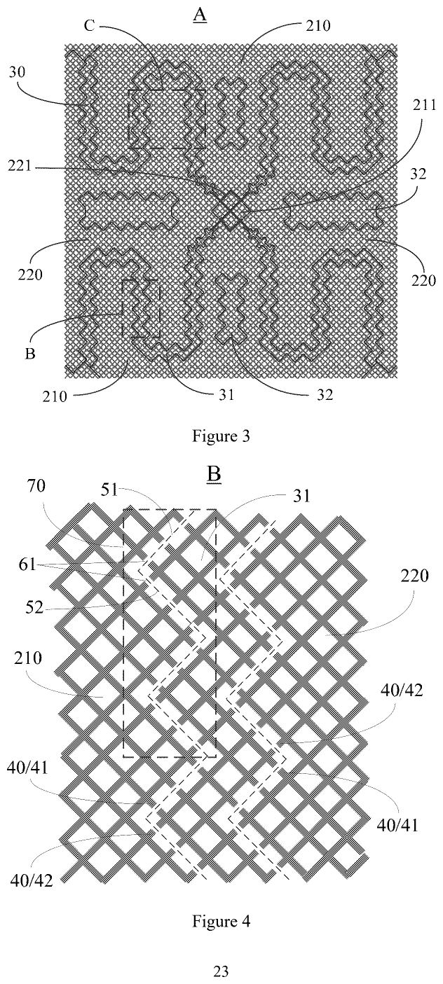

In order to explain a specific structure of the display panel of the present application, reference is made to FIGS. 1, 2, 3 and 4. FIG. 1 is a structural schematic view of an implementation of the touch display panel of the present application, FIG. 2 is a schematic view of the arrangement of first electrodes and second electrodes of the touch panel in FIG. 1, FIG. 3 is a structural schematic enlarged view of an implementation of area A in FIG. 2, and FIG. 4 is a structural schematic enlarged view of a first implementation of area B in FIG. 3.

In this implementation, the touch display panel 100 includes a touch panel 20 and a display panel 10 stacked with the touch panel 20.

In some implementations, the display panel 10 may be a flexible substrate or a rigid substrate. In some implementations, the display panel 10 may be a polymer substrate, a plastic substrate, or an ultra-thin glass substrate. In other implementations, the display panel 10 may be a glass substrate. This is not limited in the present application.

In this implementation, the touch panel 20 includes a mesh electrode layer. The mesh electrode layer includes a first touch electrode 21, a second touch electrode 22 and a first dummy electrode 31 which are insulated from one another. A first break 61 is provided between any two of the first touch electrode 21, the second touch electrode 22 and the first dummy electrode 31. An arrangement of adjacent first breaks of the plurality of first breaks 61 is defined to form a dummy pattern, the dummy pattern including a plurality of polyline-shaped dummy repeating units 70.

The mesh electrode layer is formed by a plurality of conductive mesh lines intersecting with each other, and the first touch electrode 21, the second touch electrode 22 and the first dummy electrode 31 are obtained by cutting parts of the mesh lines of all the conductive mesh lines.

In some implementations, a material for making the conductive mesh lines is metal, such as copper. In other implementations, the material forming the conductive mesh lines is a conductive oxide, such as indium tin oxide (ITO), which is not limited in the present application.

In some implementations, the first touch electrode 21 is a driving electrode, and the second touch electrode 22 is a sensing electrode. In other implementations, it is also possible that the first touch electrode 21 is a sensing electrode, and the second touch electrode 22 is a driving electrode. This is not limited in the present application.

In some implementations, the first touch electrode 21 includes a plurality of electrically connected first sub-electrodes 210, and the second touch electrode 22 includes a plurality of electrically connected second sub-electrodes 220. The plurality of first sub-electrodes 210 of the first touch electrode 21 are arranged at intervals in a first direction x, and the plurality of second sub-electrodes 220 of the second touch electrode 22 are arranged at intervals in a second direction y. The first touch electrode 21 passes between two adjacent second sub-electrodes 220, and a second touch electrode 22 passes between two adjacent first sub-electrodes 210.

The first direction x intersects with the second direction y. In some implementations, the first direction x is perpendicular to the second direction y.

In some implementations, two adjacent first sub-electrodes 210 are connected to each other by means of a connecting portion 211 to form an integral structure, and two adjacent second sub-electrodes 220 are electrically connected to each other by means of a connecting bridge 221.

The connecting portion 211, the first sub-electrode 210 and the second sub-electrode 220 are arranged in the same layer, and the connecting bridge 221 is arranged in a bridge layer, such that the first sub-electrode 210 and the second sub-electrode 220 adjacent to each other are insulated from each other.

In an implementation, the first dummy electrode 31 is arranged between the first sub-electrode 210 and the second sub-electrode 220 adjacent to each other. A plurality of conductive mesh lines 40 having first breaks 61 are provided between the first dummy electrode 31 and the first sub-electrodes 210 or the second sub-electrodes 220 adjacent to the first dummy electrode. Each first break 61 separates the conductive mesh line 40, where the first break is located, into two mesh line segments. One of the two mesh line segments belongs to the first sub-electrode 210 or the second sub-electrode 220, and the other mesh line segment belongs to the first dummy electrode 31.

In some implementations, as shown in FIG. 4, a plurality of conductive mesh lines 40 having first breaks 61 are provided between the first dummy electrode 31 and the first sub-electrode 210 on the left side. Each first break 61 separates the conductive mesh line 40, where the first break is located, into two mesh line segments. One of the two mesh line segments belongs to the first sub-electrode 210 on the left side, and the other mesh line segment belongs to the first dummy electrode 31. A plurality of conductive mesh lines 40 having first breaks 61 are provided between the first dummy electrode 31 and the second sub-electrode 220 on the right side. Each first break 61 separates the conductive mesh line 40, where the first break is located, into two mesh line segments. One of the two mesh line segments belongs to the second sub-electrode 220 on the right side, and the other mesh line segment belongs to the first dummy electrode 31.

The first break 61 refers to an isolation break that completely cuts the conductive mesh line 40 apart, and there is no electrical connection between the two mesh line segments separated by the first break 61.

In some implementations, at least part of the first break 61 is located at a midpoint of a side of a corresponding cell within the conductive mesh lines 40.

In some implementations, a plurality of first breaks 61 extend successively in the form of a polyline to form a plurality of first polylines 51 and a plurality of second polylines 52 that are alternately arranged and connected end to end. The first breaks 61 distributed along the first polyline 51 are located on a plurality of parallel first mesh lines 41, and the first breaks 61 distributed along the second polyline 52 are located on a plurality of parallel second mesh lines 42. The first mesh line 41 intersects with the second mesh line 42. It should be noted that the first polyline 51 and the second polyline 42 are shown as dash lines.

In some implementations, the first mesh line 41 is perpendicular to the second mesh line 42.

In some implementations, the first polyline 51 is perpendicular to the second polyline 52.

It should be understood that, since the plurality of successively extending first breaks 61 are provided in the demarcation areas between the first dummy electrode 31 and the first sub-electrodes 210 and the second sub-electrodes 220 that are adjacent to the first dummy electrode, the first dummy electrode 31 is insulated from the first sub-electrodes 210 and the second sub-electrodes 220 that are adjacent to the first dummy electrode.

In some implementations, the dummy pattern is formed by defining the arrangement of adjacent first breaks of the plurality of first breaks 61 such that the first breaks as a whole extend in the first direction x or the second direction y. As shown in FIG. 4, adjacent first breaks of the plurality of first breaks 61 in area B as a whole extend in the first direction x to form the dummy pattern. As exemplified in FIG. 4, each dummy repeating unit 70 of the dummy pattern may include two first polylines 51 and two second polylines 52.

In some implementations, the dummy repeating unit 70 includes a first dummy polyline unit and a second dummy polyline unit connected end to end, the dummy repeating unit 70 being a W-like pattern.

The first dummy polyline unit and the second dummy polyline unit each include one first polyline 51 and one second polyline 52 connected end to end. As shown in FIG. 4, each first dummy polyline unit and each second dummy polyline unit are V-like patterns.

It should be understood that, compared with ports extending in a vertical or horizontal direction, in this implementation, the plurality of first breaks 61 extend successively in the form of a polyline, the arrangement of adjacent first breaks of the plurality of first breaks 61 is defined to form the dummy pattern, and the dummy pattern includes the plurality of polyline-shaped dummy repeating units 70, so that the same number of first breaks 61 can be made more dispersed to reduce the intensity of the shadows of the breaks at certain specific locations, the gap shadows then become slightly fuzzy or even invisible, the effect of reducing the gap shadows is then achieved, and the display effect of the touch display panel 100 is thus improved.

In some implementations, the number of first breaks 61 distributed in each dummy repeating unit 70 is 4 to 20. In some specific implementations, the number of first breaks 61 distributed in each dummy repeating unit 70 is 8. In other implementations, as shown in FIG. 4, the number of first breaks 61 distributed in each dummy repeating unit 70 is 12. In still other implementations, the number of first breaks 61 distributed in each dummy repeating unit 70 is 16, which is not limited in the present application.

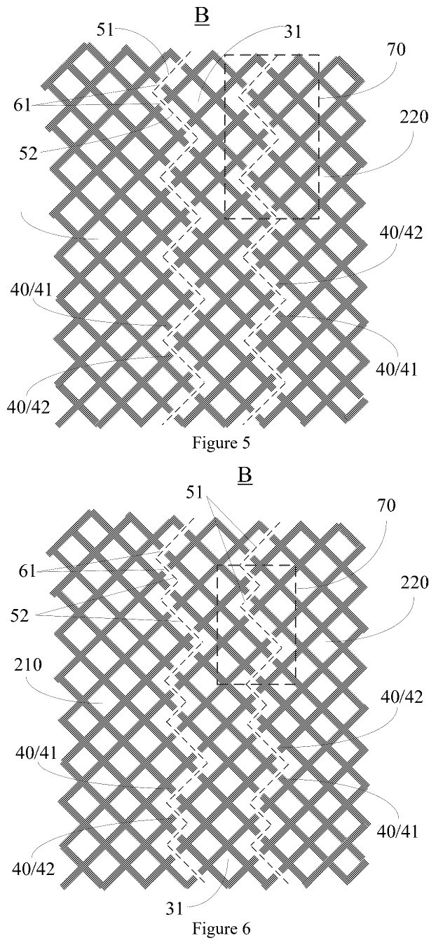

In some implementations, as shown in FIGS. 4 and 5, the number of first breaks 61 in the first dummy polyline unit is the same as the number of first breaks 61 in the second dummy polyline unit, and a distribution density of the first breaks 61 in the first dummy polyline unit is the same as a distribution density of the first breaks 61 in the second dummy polyline unit.

In some implementations, the number of first breaks in the first dummy polyline unit is 2 to 10. In other implementations, the number of first breaks in the first dummy polyline unit is 6 to 10. In some specific implementations, the number of first breaks 61 in the first dummy polyline unit is 2. In other specific implementations, the number of first breaks 61 in the first dummy polyline unit is 4. In still other implementations, the number of first breaks 61 in the first dummy polyline unit is 6. It should be understood that the numbers of first breaks 61 distributed in the first polyline 51 and the second polyline 52 may be adjusted as required to vary the density of the polylines. The number of first breaks 61 may be increased or decreased accordingly, which is not limited in the present application.

In some specific implementations, with continued reference to FIG. 4, the numbers of first breaks 61 distributed in the plurality of first polylines 51 and the plurality of second polylines 52 connected end to end are both three, the three first breaks 61 distributed in the first polyline 51 are located on three first mesh lines 41 sequentially arranged in parallel, and the three first breaks 61 distributed in the second polyline 52 are located on three second mesh lines 42 sequentially arranged in parallel, that is, the numbers of first breaks 61 in the first dummy polyline unit and the second dummy polyline unit are both 6.

In other specific implementations, referring to the FIG. 5, FIG. 5 is a structural schematic enlarged view of a second implementation of area B in FIG. 3. As shown in FIG. 5, the numbers of first breaks 61 distributed in the plurality of first polylines 51 and the plurality of second polylines 52 connected end to end are both two, the two first breaks 61 distributed in the first polyline 51 are located on two first mesh lines 41 arranged in parallel, and the two first breaks 61 distributed in the second polyline 52 are located on two second mesh lines 42 arranged in parallel, that is, the numbers of first breaks 61 in the first dummy polyline unit and the second dummy polyline unit are both 4.

In some implementations, as shown in FIG. 6, the number of first breaks 61 in the first dummy polyline unit is different from the number of first breaks 61 in the second dummy polyline unit. In some implementations, the number of first breaks in the first dummy polyline unit is 2 to 4, and the number of first breaks in the second dummy polyline unit is 6 to 10. In some specific implementations, the number of first breaks 61 in the first dummy polyline unit is 2, and the number of first breaks 61 in the second dummy polyline unit is 4. In other specific implementations, the number of first breaks 61 in the first dummy polyline unit is 4, and the number of first breaks 61 in the second dummy polyline unit is 6. In still other specific implementations, the number of first breaks 61 in the first dummy polyline unit is 4, and the number of first breaks 61 in the second dummy polyline unit is 8. This is not limited in the present application.

In some specific implementations, referring to the FIG. 6, FIG. 6 is a structural schematic enlarged view of a third implementation of area B in FIG. 3. As shown in FIG. 6, a pattern corresponding to the first dummy polyline unit is a small V-shaped pattern, and a pattern corresponding to the second dummy polyline unit is a large V-shaped pattern. Only one first break 61 is distributed in each of the first polyline 51 and the second polyline 52 forming the first dummy polyline unit, that is, the number of first breaks 61 in the first dummy polyline unit is 2. Two first breaks 61 are distributed in each of the first polyline 51 and the second polyline 52 forming the second dummy polyline unit, that is, the number of first breaks 61 in the second dummy polyline unit is 4.

It should be understood that by setting the number of first breaks 61 distributed in the first dummy polyline unit to be less than the number of first breaks 61 distributed in the second dummy polyline unit, the continuous polyline can be distributed with alternate dense and sparse segments, and the distribution continuity of the breaks can thus be broken.

The first breaks 61 in the above implementation are each arranged at a midpoint of a side of a corresponding cell within the conductive mesh lines 40, and in other implementations, the first break 61 may be arranged at a different position of the conductive mesh line 40, for example, at a vertex of a corresponding cell within the conductive mesh lines 40.

In some implementations, the plurality of first breaks 61 include a first break 61 disposed at a vertex of a corresponding cell within the conductive mesh lines 40, and another first break 61 disposed at a midpoint of a side of a corresponding cell within the conductive mesh lines 40.

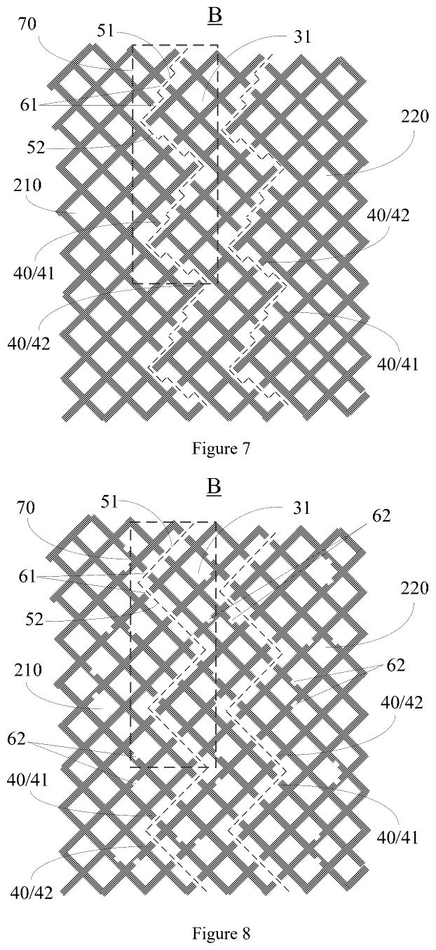

In some specific implementations, referring to the FIG. 7, FIG. 7 is a structural schematic enlarged view of a fourth implementation of area B in FIG. 3. As shown in FIG. 7, the dummy repeating unit includes dummy line segments. The plurality of first breaks 61 in the dummy line segments are arranged along a diagonal line of a pattern formed by at least two adjacent cells. In an embodiment of the present application, the dummy line segments are the first polyline 51 and the second polyline 52 shown in FIG. 7. The first polyline 51 and the second polyline 52 forming the first dummy polyline unit both span two adjacent cells, and the first polyline 51 and the second polyline 52 forming the second dummy polyline unit both spans two adjacent cells.

In one embodiment, the dummy line segment includes three first breaks 61. The three first breaks 61 are respectively located at two opposite vertices of at least two adjacent cells spanned by the dummy line segment, and at a midpoint of a shared side of the two adjacent cells.

The numbers of first breaks located on any one first polyline 51 and any one second polyline 52 are both three, and the first breaks are respectively located at two opposite vertices of two adjacent cells spanned by the polyline, and at the midpoint of the shared side of the two adjacent cells.

The number of first breaks 61 distributed along each first polyline 51 is three, and the three first breaks 61 are respectively located on three first mesh lines 41 sequentially arranged in parallel. The first one of the first breaks 61 is located at a left vertex of the first mesh line 41 where it is located, the second one of the first breaks 61 is located at a midpoint of the first mesh line 41 where it is located, and the third one of the first breaks 61 is located at a right vertex of the first mesh line 41 where it is located. The number of first breaks 61 distributed along each second polyline 52 is three, and the three first breaks 61 are respectively located on three second mesh lines 42 sequentially arranged in parallel. The first one of the first breaks 61 is located at a left vertex of the second mesh line 42 where it is located, the second one of the first breaks 61 is located at a midpoint of the second mesh line 42 where it is located, and the third one of the first breaks 61 is located at a right vertex of the second mesh line 42 where it is located.

It should be understood that, by uniformly providing the plurality of sequentially arranged first breaks 61 at a right vertex, a midpoint and a left vertex of the first mesh lines 41 or the second mesh lines 42, compared with providing all or most of the first breaks 61 at the midpoints of the sides of the corresponding cells within the conductive mesh lines 40, the concentration of the break shadows can be reduced, and the visibility of the break shadows can thus be further reduced.

In some implementations, parts of the conductive mesh lines 40 of the first sub-electrodes 210, the second sub-electrodes 220 and the first dummy electrode 31 have a plurality of second breaks 62 provided on.

The second break 62 refers to a non-isolation break formed by partially cutting the conductive mesh line 40, and there is an electrical connection between two mesh line segments at two ends of the second break 62.

In some specific implementations, referring to the FIG. 8, FIG. 8 is a structural schematic enlarged view of a fifth implementation of area B in FIG. 3. As shown in FIG. 8, parts of the conductive mesh lines 40 of the first sub-electrodes 210, the second sub-electrodes 220 and the first dummy electrodes 31 have a plurality of second breaks 62 provided on. Two adjacent second breaks 62 are respectively provided on a first mesh line 41 and a second mesh line 42 that intersect with each other. In other specific implementations, it is possible that only the first mesh lines 41 or the second mesh lines 42 have a plurality of second breaks 62 provided on, which is not limited in the present application.

It should be understood that the second breaks 62 provided on parts of the conductive mesh lines 40 of the first sub-electrodes 210, the second sub-electrodes 220 and the first dummy electrodes 31 also have an effect of generating break shadows, and can thus confuse the break shadows formed by the first breaks 61, thereby reducing the visibility of the break shadows.

In some implementations, a distribution density of the second breaks 62 close to the first breaks 61 is greater than a distribution density of the second breaks remote from the first breaks 61.

In some implementations, the number of second breaks in a plurality of adjacent cells close to the first breaks 61 is greater than the number of second breaks in a plurality of adjacent cells remote from the first breaks 61.

In some implementations, the number of second breaks 62 distributed in a square pattern formed by every four adjacent cells close to the first breaks 61 is 5 to 8. The number of second breaks 62 distributed in a square pattern formed by every four adjacent cells remote from the first breaks 61 is 0 to 4.

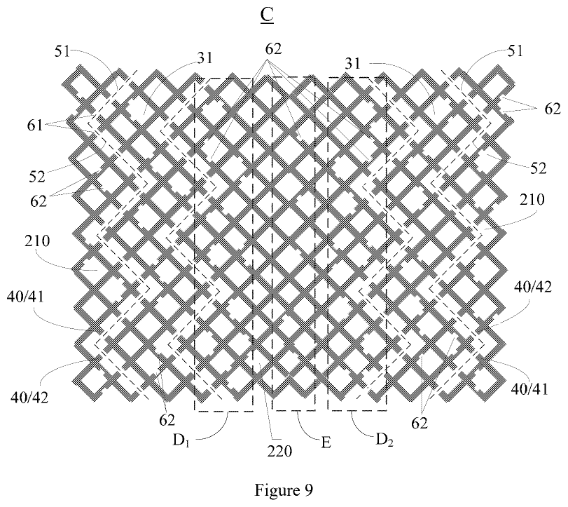

In some specific implementations, referring to the FIG. 9, FIG. 9 is a structural schematic enlarged view of an implementation of area C in FIG. 3. Second breaks 62 are provided on parts of the conductive mesh lines 40 of the first sub-electrodes 210, the second sub-electrodes 220 and the first dummy electrodes 31. The first dummy electrodes 31 are provided on the left side and the right side of the second sub-electrode 220. The second sub-electrode 220 includes area D₁, area D₂ and area E. The area D₁ is close to the first dummy electrode 31 on the left side, the area D₂ is close to the first dummy electrode 31 on the right side, the area E is located in the middle and remote from the first dummy electrodes 31 on the two sides, that is, the area D₁ and the area D₂ are both close to the first breaks 61, and the area E is remote from the first breaks 61. As shown in FIG. 9, in the area D₁ and the area D₂, the number of second breaks 62 distributed in a square pattern formed by every four adjacent cells is 5 to 8. In the area E, the number of second breaks 62 distributed in a square pattern formed by every four adjacent cells is 0 to 4.

It should be understood that, by setting the distribution density of the second breaks 62 close to the first breaks 61 to be greater than the distribution density of the second breaks 62 remote from the first breaks 61, the break shadows can transition more smoothly, thereby further reducing the break shadows.

Further, in some implementations, a plurality of second dummy electrodes are provided in the first sub-electrode 210, and the second dummy electrodes are insulated from the first sub-electrodes 210. In other implementations, a plurality of second dummy electrodes are provided in the second sub-electrode 220, and the second dummy electrodes are insulated from the second sub-electrodes 220. In still other implementations, a plurality of second dummy electrodes are provided in each of the first sub-electrode 210 and the second sub-electrode 220. This is not limited in the present application.

With continued reference to FIG. 3, in some specific implementations, a plurality of second dummy electrodes 32 are provided in the first sub-electrode 210, and the second dummy electrodes 32 are insulated from the first sub-electrodes 210. A plurality of second dummy electrodes 32 are provided in the second sub-electrode 220, and the second dummy electrodes 32 are insulated from the second sub-electrodes 220.

It should be understood that, by providing the first dummy electrode 31 in the demarcation area between the first sub-electrode 210 and the second sub-electrode 220 that are adjacent to each other, and providing the second dummy electrodes 32 inside the first sub-electrode 210 and/or the second sub-electrode 220, the electrode area of the touch electrodes in the touch panel 20 can be decreased, the self-capacitance and charging time between the touch electrode and the cathode can be decreased (i.e., a capacitive load of the touch electrodes can be reduced), the scanning frequency and the report rate can then be increased, and the touch sensitivity can thus be improved.

Correspondingly, the present application provides a touch display device, including any one of the touch display panels described above.

Different from the related art, in this implementation, the first breaks are provided between the touch electrode and the first dummy electrode, the arrangement of adjacent first breaks of the plurality of first breaks is defined to form the dummy pattern, and the dummy pattern includes the plurality of polyline-shaped dummy repeating units, so that the dispersion of the first breaks can be increased to break the continuity of the breaks in a demarcation area, break shadows are then effectively reduced, and the display effect of the touch display panel is thus improved. Moreover, by providing the second breaks on parts of the conductive mesh lines of the first sub-electrodes, the second sub-electrodes and the first dummy electrodes, and by setting the distribution density of the second breaks close to the first breaks to be greater than the distribution density of the second breaks remote from the first breaks, the visibility of the break shadows can be further reduced, thereby further improving the display effect of the touch display panel.

The above are merely the embodiments of the present application and are not intended to limit the patent scope of the present application, and any equivalent structure or equivalent process alternation made by using the content of the specification and drawings of the present application, or an application of the content of the specification and drawings directly or indirectly to another related field, shall fall within the scope of protection of the present application.

1. A touch panel, comprising:
a mesh electrode layer, comprising a first touch electrode, a second touch electrode and a first dummy electrode which are insulated from one another, and a plurality of first breaks, any two of the first touch electrode, the second touch electrode and the first dummy electrode having a part of the first breaks provided therebetween,
wherein adjacent first breaks of the plurality of first breaks are arranged to form a dummy pattern, the dummy pattern comprising a plurality of polyline-shaped dummy repeating units.

2. The touch panel according to claim 1, wherein the dummy repeating unit comprises a first dummy polyline unit and a second dummy polyline unit connected end to end, and the dummy repeating unit is a W-like pattern.

3. The touch panel according to claim 1, wherein the number of first breaks distributed in the dummy repeating unit is 4 to 20.

4. The touch panel according to claim 2, wherein the number of first breaks in the first dummy polyline unit is the same as the number of first breaks in the second dummy polyline unit; and
a distribution density of the first breaks in the first dummy polyline unit is the same as a distribution density of all the first breaks in the second dummy polyline unit.

5. The touch panel according to claim 4, wherein the number of first breaks in the first dummy polyline unit is 6 to 10.

6. The touch panel according to claim 2, wherein the number of first breaks in the first dummy polyline unit is different from the number of first breaks in the second dummy polyline unit.

7. The touch panel according to claim 6, wherein the number of first breaks in the first dummy polyline unit is 2 to 4, and the number of first breaks in the second dummy polyline unit is 4 to 10.

8. The touch panel according to claim 1, wherein the mesh electrode layer comprises a plurality of conductive mesh lines; and
the plurality of adjacent first breaks comprise a first break disposed at a vertex of a corresponding cell within the plurality of conductive mesh lines, and another first break disposed at a midpoint of a side of a corresponding cell within the plurality of conductive mesh lines.

9. The touch panel according to claim 8, wherein the dummy repeating unit comprises dummy line segments, the plurality of first breaks in the dummy line segments being arranged along a diagonal line of a pattern formed by at least two adjacent cells; and
each dummy line segment comprises three first breaks, the three first breaks being respectively located at two opposite vertices of at least two adjacent cells spanned by the dummy line segment, and at a midpoint of a shared side of the two adjacent cells.

10. The touch panel according to claim 1, wherein the first touch electrode comprises a plurality of electrically connected first sub-electrodes, the second touch electrode comprises a plurality of electrically connected second sub-electrodes, parts of the plurality of conductive mesh lines of the first sub-electrodes, the second sub-electrodes and the first dummy electrodes having a plurality of second breaks provided thereon.

11. The touch panel according to claim 10, wherein a distribution density of the second breaks close to the first breaks is greater than a distribution density of the second breaks remote from the first breaks; and
the number of second breaks in a plurality of adjacent cells close to the first breaks is greater than the number of second breaks in a plurality of adjacent cells remote from the first breaks.

12. The touch panel according to claim 10, wherein the number of second breaks distributed in a square pattern formed by every four adjacent cells close to the first breaks is 5 to 8; and
the number of second breaks distributed in a square pattern formed by every four adjacent cells remote from the first breaks is 0 to 4.

13. The touch panel according to claim 10, wherein a plurality of second dummy electrodes are provided in the first sub-electrode, and the second dummy electrodes are insulated from the first sub-electrode.

14. The touch panel according to claim 10, wherein a plurality of second dummy electrodes are provided in the second sub-electrode, and the second dummy electrodes are insulated from the second sub-electrode.

15. A touch display panel, comprising:
a touch panel, comprising:
a mesh electrode layer, comprising a first touch electrode, a second touch electrode and a first dummy electrode which are insulated from one another, and a plurality of first breaks, any two of the first touch electrode, the second touch electrode and the first dummy electrode having a part of the first breaks provided therebetween,
wherein adjacent first breaks of the plurality of first breaks are arranged to form a dummy pattern, the dummy pattern comprising a plurality of polyline-shaped dummy repeating units, wherein the touch display panel further comprises a display panel stacked with the touch panel.

16. A display device, comprising:
a touch display panel, comprising:
a mesh electrode layer, comprising a first touch electrode, a second touch electrode and a first dummy electrode which are insulated from one another, and a plurality of first breaks, any two of the first touch electrode, the second touch electrode and the first dummy electrode having a part of the first breaks provided therebetween,
wherein adjacent first breaks of the plurality of first breaks are arranged to form a dummy pattern, the dummy pattern comprising a plurality of polyline-shaped dummy repeating units,
wherein the touch display panel further comprises a display panel stacked with the touch panel.
